(19) United States
(12) Patent Application Publication
(10) Pub. No.: US 2008/0298480 A1
(43) Pub. Date: Dec. 4, 2008

(54) Asynchronous MIMO-OFDM spatial covariance estimation

(76) Inventors: Qiang Li, Hillsboro, OR (US); Jing Zhu, Hillsboro, OR (US)

Correspondence Address: RYDER IP LAW;C/O INTELLEVATE, LLC, P. O. BOX 52050, MINNEAPOLIS, MN, 55402, US

(21) Appl. No.: 11/807,985

(22) Filed: May 31, 2007

(51) Int. Cl. H04L 23/02

(52) U.S. Cl. 375/260

(57) ABSTRACT

In general, in one aspect, the disclosure describes an apparatus that includes a sample averager to construct a preliminary estimate of a spatial covariance matrix from a received communications signal. A time-domain filter with Cholesky decomposition is used to decompose the preliminary estimate of the spatial covariance matrix into product of an upper triangular matrix and complex conjugate of the upper triangular matrix. The time-domain filter with Cholesky decomposition is also used to filter the upper triangular matrix and construct an updated estimate of the spatial covariance matrix using the filtered upper triangular matrix.

### BACKGROUND

The widespread deployment of local and wide-area wireless networks (wireless local area networks (WLAN) and wireless metropolitan area networks (WMAN)) allows users of mobile equipment to enjoy the benefits of wideband access to the Internet and other digital services. Ubiquitous provision of wireless networking requires the operation of a vast array of base stations and access points. The growth of these services, however, depends on the aggressive reuse of a limited number of frequency channels. For example, certain WMANs may support “frequency reuse one” where all cells operate on the same frequency channel. Co-channel interference (CCI), the inevitable result of such aggressive reuse, is becoming the dominant limit to the growth of these systems and services.

Many modern wireless standards use Orthogonal Frequency Division Multiplexing (OFDM) as the radio communications method to improve multipath performance. These systems may also use multiple antennas on the transmitters and receivers, referred to as Multiple-Input Multiple-Output (MIMO), to cancel interference from adjacent cells. In such systems, if interfering signals are synchronized with the intended signal, interference can be treated independently on each sub-carrier, and therefore cancelled in a straight-forward manner. However, synchronizing the signals in multiple cells is not always possible. If interfering signals and intended signals are not synchronized (asynchronous CCI), a receiver may estimate the spatial covariance matrix of the interference on each sub-carrier for the purpose of cancellation. The accuracy of this estimation determines the performance of the cancellation process.

### BRIEF DESCRIPTION OF THE DRAWINGS

The features and advantages of the various embodiments will become apparent from the following detailed description in which:

FIG. 1 illustrates a functional block diagram of an example MIMO OFDM communication system, according to one embodiment; and

FIG. 2 illustrates a functional block diagram of an example CCI estimator, according to one embodiment.

### DETAILED DESCRIPTION

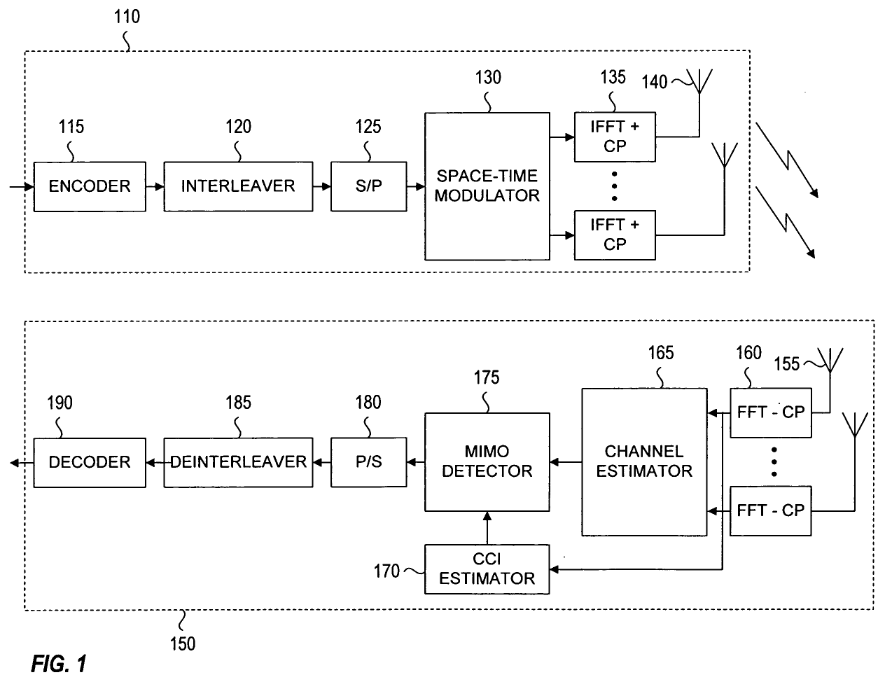

FIG. 1 illustrates a functional block diagram of an example MIMO OFDM communication system 100. The system includes a transmitter 110 and a receiver 150. The transmitter 100 may be included in a first wireless communications device and the receiver 105 may be included in a second wireless communications device. Certain wireless communications devices may include the transmitter and one receiver to allow the device to both send and receive data.

The transmitter 110 includes an encoder 115, an interleaver 120, a serial/parallel (S/P) converter 125, a space time modulator 130, one or more Inverse-Fast-Fourier-Transforms (IFFT) with cyclic prefix (CP) adder (IFFT+CP) 135, and one or more antennas 140. Data enters the transmitter 110 at the encoder 115. The encoder 115 performs forward error correction (FEC) encoding on the data to help protect the signal from transmission errors. The encoded data enters the interleaver 120 where it is interleaved (to improve correction of burst errors). The data is then partitioned into blocks in the S/P converter 125. The data blocks may be modulated in the space-time modulator 130 and then divided into M groups. An IFFT+CP 135 receives a group of modulated data blocks and converts them to a time-domain signal and may add a CP to the time-domain signal to mitigate the effects of multipath-related intersymbol interference. An antenna 140 receives the output of the IFFT+CP 135 and transmits the data therefrom.

The receiver 150 includes one of more antennas 155, one or more Fast-Fourier-Transforms (FFT) with CP remover (FFT-CP) 160, a channel estimator 165, a CCI estimator 170, a MIMO detector 175, a parallel/serial (P/S) converter 180, a deinterleaver 185, and a decoder 190. Data (time domain signals) is received by the one or more antennas 155. A FFT-CP 160 may remove the cyclic prefix from the received data and transform the time-domain signals into the frequency domain. The channel estimator 165 receives the frequency domain signals and estimates characteristics of transmission channel (channel transfer function) to equalize the received signals. The CCI estimator 170 also receives the frequency domain signals and estimates CCI. The MIMO detector 175 receives the equalized signals and the CCI estimate and cancels the CCI from the estimated signals and demodulates the resulting signals (received data blocks). The P/S converter 180 reconstructs the data blocks into an encoded serial data stream. The deinterleaver 185 deinterleaves the encoded serial stream and the decoder 190 provides error correction.

In the general case, the narrowband and synchronous signal for each tone (sub-carrier) i received at the receiver 150 can be modeled as Y(i)=H(i)·s(i)+G(i)·x(i)+N(i), where i=1 . . . N_{FFT}, Y(i) is the received signal vector at the i^{th} tone, s(i) is the transmitted signal, H(i) is the channel matrix (transfer function) of the transmitted signal, x(i) is the interfering signal, G(i) is the channel matrix of the interfering signal, and N(i) is an additive white Gaussian noise (AWGN) vector with variance σ² for each element. The goal of the receiver 150 is to estimate the transmitted signal from the received signal.

For the case of asynchronous interference, the cyclic structure of each interfering OFDM signal is destroyed. In this case, we cannot distinguish the interfering signal from the noise, so we may lump the interference and noise into a single term I(i) to yield Y(i)=H(i)·s(i)+I(i). The goal in this case is to efficiently estimate the spatial covariance of I(i) for each tone (using the CCI estimator 170) and use this information to recover the transmitted signal.

If a space-time block coding (STBC) transmission scheme is used, we can express the equivalent spatio-temporal signal model for a 2×2 case by stacking two receive vector samples (y₁ and y₂):

$$[ \begin{matrix}{y}_{1} ( 1 ) \\ {y}_{2} ( 1 ) \\ {y}_{1}^{*} ( 2 ) \\ {y}_{2}^{*} ( 2 )\end{matrix} ] = [ \begin{matrix}{h}_{11} ( 1 ) & {h}_{12} ( 1 ) \\ {h}_{21} ( 1 ) & {h}_{22} ( 1 ) \\ {h}_{12}^{*} ( 2 ) & - {h}_{11}^{*} ( 2 ) \\ {h}_{22}^{*} ( 2 ) & - {h}_{21}^{*} ( 2 )\end{matrix} ] [ \begin{matrix}{s}_{1} \\ {s}_{2}\end{matrix} ] + [ \begin{matrix}{I}_{1} \\ {I}_{2} \\ {I}_{3} \\ {I}_{4}\end{matrix} ] .$$

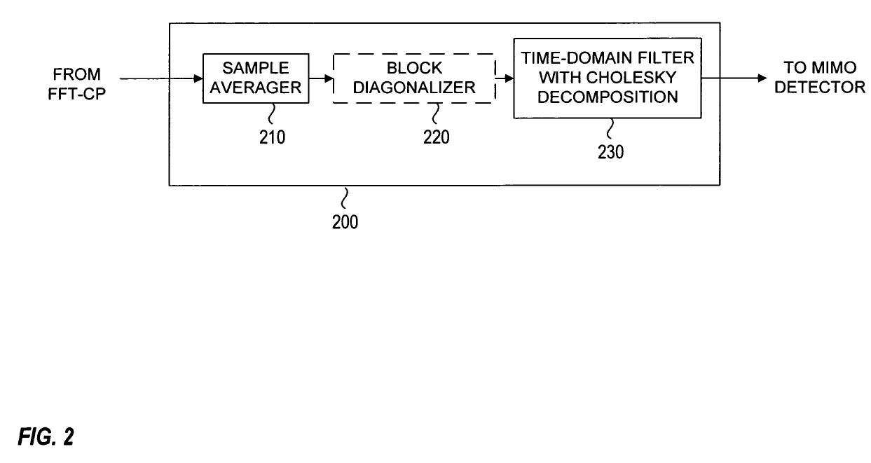

FIG. 2 illustrates a block diagram of an example CCI estimator 200 (e.g., 170 of FIG. 1) utilized in an OFDM MIMO receiver (e.g., 170). The CCI estimator 200 includes a sample averager 210 and a time-domain filter with Cholesky decomposition 230. The CCI estimator 200 may also include a block diagonalizer 220 if STBC is used.

The sample averager 210 receives frequency domain versions of the signals received by the receiver. The frequency domain signals may be received from an FFT-CP (e.g., 160). The sample averager 210 measures I(i) for each tone. This may be implemented by adding “zero” samples (called zero-padding or training symbols) to various positions in a transmitted packet. The receiver, having knowledge of the position of these zero samples, may make measurements of the interfering signal during these periods. These measurements may be made over several OFDM symbols. Short duration measurement may be required in most applications. An initial spatial covariance matrix Rₗₗ is computed for each tone i as:

$${R}_{II} ( i ) = \frac{1}{K} {\sum }_{k = 0}^{K - 1} I ( i ) \cdot {I ( i )}^{H} ,$$

where K is the zero-padding or training OFDM symbol number. The structure of the spatial covariance matrix is Hermitian and positive definite.

The block diagonalizer 220, employed when STBC is used, may treat the interferences at two successive slots as independent to reduce the number of elements in the covariance matrix that need measuring so that Rₗₗ will have the following block diagonal form:

$${R}_{II} = [ \begin{matrix}{R}_{11} & {R}_{12} & 0 & 0 \\ {R}_{21} & {R}_{22} & 0 & 0 \\ 0 & 0 & {R}_{33} & {R}_{34} \\ 0 & 0 & {R}_{43} & {R}_{44}\end{matrix} ] = [ \begin{matrix}{R}_{II 2 \times 2}^{( 1 )} & 0 \\ 0 & {R}_{II 2 \times 2}^{( 2 )}\end{matrix} ] .$$

If STBC is not used, the interferences may skip the block diagonalizer 220 and be provided directly to the Time-Domain Filter with Cholesky Decomposition 230.

The Time-Domain Filter with Cholesky Decomposition 230 makes use of the fact that the spatial covariance matrix is Hermitian and positive definite. The well-known Cholesky Decomposition is used to decompose the matrix into an upper triangular matrix (sometimes referred to as the “square root” matrix) and the conjugate transpose of the same upper triangular matrix for tone i as Rₗₗ(i)=U(i)^{H}U(i), where U(i) is an upper triangular matrix.

The frequency domain power or mutual power spectral density Rₗₗ(i)[m,n] corresponds to the time domain auto-correlation or cross-correlation, where m and n are the row and column indices of matrix Rₗₗ(i), and used to identify the receiving antennas. Due to the limited channel delay taps and independently transmitted data, the interferences received at antenna m and antenna n are correlated only within a limited time interval. Accordingly, Rₗₗ(i)[m,n] needs to be filtered (low pass) in the time domain.

A time-domain representation of power spectral density rₗₗ[m,n] can be found by computing the Inverse Fast Fourier Transform (IFFT) of the frequency domain power spectral density Rₗₗ(i)[m,n], rₗₗ[m,n]=IFFT(Rₗₗ[m,n]). The time-domain power spectral density rₗₗ[m,n] may be low pass filtered by setting it equal to zero for time range outside of the maximum delay tap, rₗₗ[m,n](t)=0, for |t|>L, where L is the maximum delay tap of the multi-path channel.

Since the filtering operation described above would destroy the positive definite structure of Rₗₗ(i), U(i) (the square-root of Rₗₗ(i), the upper triangular matrix) may be filtered and an updated estimate for Rₗₗ(i) may be constructed as \tilde{R}ₗₗ(i)=Ũ(i)^{H}Ũ(i), where Ũ(i) is the filtered output.

The filtering operation may also be realized by a weighting operation instead of the IFFT operation. For example,

$$P = {FDF}^{H} , \\ D = diag ( {d}_{t} ) , \\ {d}_{t} = \{ \begin{matrix}1 , & t \leq L , t \geq {N}_{FFT} - L + 1 \\ 0 , & L < t < {N}_{FFT} - L + 1\end{matrix} t = 1 … {N}_{FFT}$$

where F is an FFT matrix, and Ũ(i)=P·U(i). The weight matrix F may be pre-computed to reduce computations during real-time operation.

Once an estimate of the spatial covariance matrix is found, this estimate may be provided to a MIMO detector (e.g., 175) to cancel co-channel interference.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” or “in an embodiment”appearing in various places throughout the specification are not necessarily all referring to the same embodiment.

Different implementations may feature different combinations of hardware, firmware, and/or software. It may be possible to implement, for example, some or all components of various embodiments in software and/or firmware as well as hardware, as known in the art. Embodiments may be implemented in numerous types of hardware, software and firmware known in the art, for example, integrated circuits, including ASICs and other types known in the art, printed circuit broads, components, etc.

The various embodiments are intended to be protected broadly within the spirit and scope of the appended claims.

What is claimed:

1. An apparatus comprising:
a sample averager to construct a preliminary estimate of a spatial covariance matrix from a received communications signal; and
a time-domain filter with Cholesky decomposition to
decompose the preliminary estimate of the spatial covariance matrix into product of an upper triangular matrix and complex conjugate of the upper triangular matrix;
filter the upper triangular matrix; and
construct an updated estimate of the spatial covariance matrix using the filtered upper triangular matrix.

2. The apparatus of claim 1, wherein the time-domain filter with Cholesky decomposition is coupled to the sampler averager.

3. The apparatus of claim 1, wherein the time-domain filter with Cholesky decomposition is also used to generate a time domain version of the upper triangular matrix by calculating an Inverse Fast Fourier Transform for the upper triangular matrix, and the time domain version of the upper triangular matrix is filtered.

4. The apparatus of claim 3, wherein the filtering excludes time values exceeding a maximum delay tap.

5. The apparatus of claim 1, further comprising a block diagonalizer to transform the preliminary estimate of the spatial covariance matrix into a block diagonal matrix, wherein the time-domain filter with Cholesky decomposition is to decompose the block diagonal matrix.

6. The apparatus of claim 5, wherein the block diagonalizer is coupled between the sample averager and the time-domain filter with Cholesky decomposition.

7. The apparatus of claim 1, further comprising a channel estimator to estimate characteristics of transmission channels and to equalize the received signals.

8. The apparatus of claim 7, further comprising a detector to receive the equalized received signals and the updated estimate of the spatial covariance matrix to reduce interference and estimate a transmitted signal.

9. An apparatus comprising:
a channel estimator to estimate characteristics of transmission channels of received signals and to equalize the received signals;
a co-channel interference estimator to generate an initial estimate of a spatial covariance matrix for the received signals, to Cholesky decompose the spatial covariance matrix, and to filter the Cholesky decomposed spatial covariance matrix based on time to generate an updated spatial covariance matrix; and
a detector to receive the equalized received signals and the updated estimate of the spatial covariance matrix to estimate transmitted signals by reducing interference in the received signals.

10. The apparatus of claim 9, wherein the Cholesky decomposition of the preliminary estimate of the spatial covariance matrix includes an upper triangular matrix and a complex conjugate of the upper triangular matrix, and wherein co-channel interference estimator is to filter the upper triangular matrix.

11. The apparatus of claim 10, wherein the co-channel interference estimator is to generate a time domain version of the upper triangular matrix by calculating an Inverse Fast Fourier Transform for the upper triangular matrix, and to filter the time domain version of the upper triangular matrix.

12. The apparatus of claim 10, wherein the co-channel interference estimator is to filter the upper triangular matrix by weighting the matrix based on time.

13. The apparatus of claim 9, wherein the co-channel interference estimator is to transform the preliminary estimate of the spatial covariance matrix into a block diagonal matrix to reduce the number of elements in the covariance matrix that need measuring when space-time block coding is used.

14. The apparatus of claim 9, further comprising an antenna to receive signals.

15. The apparatus of claim 9, utilized in a wireless radio.
